(19) United States
(12) Patent Application Publication
(10) Pub. No.: US 2003/0201282 A1
(43) Pub. Date: Oct. 30, 2003

(54) Systems and methods for producing and dispensing automobile appearance care products

(76) Inventors: Timothy H. Floyd, Garland, TX (US); Paul David Miller III, Dallas, TX (US)

Correspondence Address: ERIC B. MEYERTONS, CONLEY, ROSE & TAYON, P.C., P.O. BOX 398, AUSTIN, TX, 78767-0398, US

(21) Appl. No.: 10/321,779

(22) Filed: Dec. 17, 2002

Related U.S. Application Data
(60) Provisional application No. 60/342,575, filed on Dec. 19, 2001.

(51) Int. Cl. B67D 5/06

(52) U.S. Cl. 222/144.5; 222/394

(57) ABSTRACT

Embodiments described herein include systems and methods for dispensing multiple automotive appearance care products. Base fluids or raw materials may be placed in containers. The base fluids may be combined with a carrier fluid to produce a product fluid. Product fluids may be stored in containers prior to use. Product fluids may be dispensed as concentrated fluids and/or fluids ready for use. Product fluids may be used as products for automotive appearance care. Certain embodiments may also include means for automatically controlling product fluid dispensing and usage. Certain embodiments include methods for monitoring usage and assessing or determining costs to be charged a user of the dispensing system.

### PRIORITY CLAIM

This application claims priority to Provisional Patent Application No. 60/342,575 entitled “Systems and methods for producing and dispensing automobile appearance care products” filed on Dec. 19, 2001.

### BACKGROUND OF THE INVENTION

1. Field of the Invention

The present invention relates to systems and methods for dispensing automotive appearance care products. Embodiments relate to a transportable, compact system for dispensing multiple automotive appearance care products.

2. Description of the Related Art

Current methods for providing customers with automotive appearance care products involve either supplying the customer with pre-made solutions in large, heavy containers or providing the customer with containers of concentrated fluids and having the customer combine the concentrated fluids with a carrier fluid, e.g., water, to obtain the desired product.

Supplying the customer with pre-made solutions requires delivery and handling of large, heavy containers, which can be costly for the customer. The heavy containers also may be difficult to move from location to location, if so desired. If the customer is a distributor, the customer must also provide a means for transferring the product from the large container to a container suitable for consumers. This process can be time consuming and material may be wasted in the transfer process. It may also be difficult for the distributor to track the amount of product given to consumers if consumers desire varying amounts of product. Storage of the large containers may also take up valuable warehouse or storage space.

Providing the customer with concentrated fluids may reduce the size of containers delivered to the customer, thus saving space and reducing delivery costs. Combining the concentrated fluids with a carrier fluid however, may result in a significant waste of time and money. In addition, improper mixing of the fluids by the customer may result in unreliable product uniformity. Again, it may be difficult for a distributor to easily track the amount of product given to a consumer if consumers desire varying amounts of product. For the customer to be provided with a variety of products, multiple concentrated fluids must be mixed with carrier fluids, which can be a difficult process and can significantly increase the difficulty in tracking product costs to be charged to a consumer.

Thus, there is a need to dispense multiple automotive appearance care products from a system that can be used to accurately track and dispense a large amount of product, saves space, and transports easily. It may also be advantageous to automatically control product dispensing.

### SUMMARY OF THE INVENTION

In an embodiment, a system for dispensing a plurality of product fluids may include a plurality of containers. Each container may contain a base fluid. A carrier fluid supply may be coupled to a first conduit to provide a source of carrier fluid. The carrier fluid may be pressurized in the system to provide a substantially constant pressure of carrier fluid. Pressurizing the carrier fluid in the system may provide a more transportable apparatus that can be moved from one location to another location without a need to modify the system. A valve coupled to the first conduit and a supply conduit may control a flow of the carrier fluid from the first conduit to the supply conduit. The base fluid may be mixed with the flow of carrier fluid in the supply conduit.

An injector may control mixing of the base fluid with the carrier fluid to form a product fluid in the supply conduit. In some embodiments, more than one injector for mixing the carrier fluid with more than one base fluid may be disposed along the supply conduit.

A metering device may be coupled to the supply conduit to determine an amount of product fluid dispensed during use. Monitoring the amount of product fluid dispensed by using a metering device may improve the ability to track and determine costs for charging users of the apparatus. A plurality of supply conduits may be disposed in the system and coupled to the first conduit. In certain embodiments, each supply conduit may produce a different product fluid. A separate metering device may be used for each product fluid dispensed.

Each product fluid may be dispensed through an exit valve. In some embodiments, more than one exit valve may be used. Multiple automotive appearance care product fluids may be dispensed in a diluted composition for immediate use. The system may be used to dispense multiple product fluids from a single apparatus regardless of the chemical compatibility of the fluids. The multiple automotive appearance care product fluids may also be dispensed in a concentrated composition requiring dilution before use.

In certain embodiments, a system for dispensing a plurality of automotive appearance care products includes a plurality of storage containers. A raw material may be placed in each storage container. One or more mixing containers may be coupled to each storage container.

Raw materials from the storage containers may be combined with a carrier fluid. The combined raw materials and carrier fluid may be provided to a plurality of mixing containers. In addition, a powder may be added, either manually or automatically, to each mixing container. The raw materials, powders, and/or carrier fluid may be combined in the mixing containers to produce a plurality of mixtures.

Mixtures from the mixing containers may be provided to a plurality of mixing systems. The mixing systems may be located in a dispensing apparatus. The mixing systems may combine the mixtures with carrier fluid to produce a plurality of product fluids. The product fluids may be dispensed to a plurality of storage vessels. A plurality of pumps may be coupled to the storage vessels to pump the product fluids from the storage vessels to a plurality of dispensing conduits. The dispensing conduits may be used to dispense automotive appearance care products that are ready for immediate use by a consumer.

Systems for dispensing a plurality of automotive appearance care products as described herein may be used in high volume areas (i.e., areas with a high throughput of automobiles processed using the automotive appearance care products). For example, a system may be used to treat between about 150 and 250 automobiles per day. Using more than one system may substantially increase a possible throughput of automobiles.

In an embodiment, a cost to be charged to a user may be based on a number of automobiles the user treats using the automotive appearance care products produced by a system for dispensing product fluids. Charges based on a number of treated automobiles, rather than on an amount of fluid dispensed or fluid used, may reduce the number of costs associated with using the automotive appearance care products that a user of the system may have to consider for budgeting.

In some embodiments, product fluids (or automotive appearance care products) may be dispensed substantially automatically by the system. Automatically dispensing products may reduce excess use of raw materials or base fluids by a user of the system. Automation may include limiting operating of the system by use of an on/off switch and/or dispensing the product fluids by operating a fluid applicator. Such automation may increase a lifetime of the system or apparatus and/or control the use of fluids and materials in the system.

### BRIEF DESCRIPTION OF THE DRAWINGS

Advantages of the present invention may become apparent to those skilled in the art with the benefit of the following detailed description of the preferred embodiments and upon reference to the accompanying drawings in which:

FIG. 1 depicts an embodiment of a system for dispensing a plurality of automotive appearance care products.

FIG. 2 depicts the inside of the embodiment of the apparatus of FIG. 1.

FIG. 3 illustrates a schematic of an embodiment of a system for dispensing a plurality of automotive appearance care products.

FIG. 4 illustrates a schematic of another embodiment of a system for dispensing a plurality of automotive appearance care products.

FIG. 5 depicts an alternate embodiment of a system for dispensing a plurality of automotive appearance care products.

FIG. 6 depicts an embodiment of an apparatus used for dispensing a plurality of automotive appearance care products.

FIG. 7 illustrates a schematic of an alternate embodiment of a system for dispensing a plurality of automotive appearance care products.

FIG. 8 illustrates a schematic of an embodiment of a supply system for dispensing an automotive appearance care product.

FIG. 9 depicts an embodiment of a mixing system.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE INVENTION

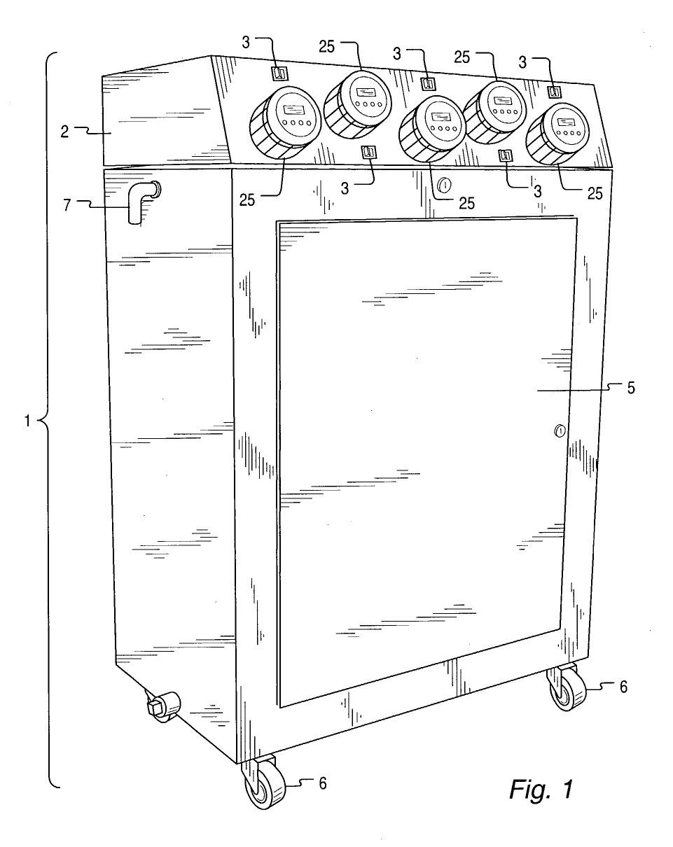

An embodiment of a compact, transportable automotive appearance care product dispensing apparatus is shown in FIG. 1. Apparatus 1 may have switches 3 and metering devices 25 located on top cabinet 2. In main cabinet 5 may be located a plurality of containers comprising base fluids for use as a component of an automotive appearance care product fluid. At least one exit valve 7 may be mounted on a side of apparatus 1 for dispensing multiple product fluids. A dispensing conduit may be coupled to exit valve 7. The dispensing conduit may be made of any material chemically inert to a dispensed fluid. Materials that may be used include rubbers, polymeric materials, and metals. The dispensing conduit may be permanently coupled to exit valve 7. The dispensing conduit may be removably coupled to exit valve 7. Removably coupling the dispensing conduit to exit valve 7 allows dispensing conduits to be changed or replaced when other types of fluids are dispensed. In an embodiment, wheels 6 are mounted on apparatus 1 to provide for mobility of the apparatus.

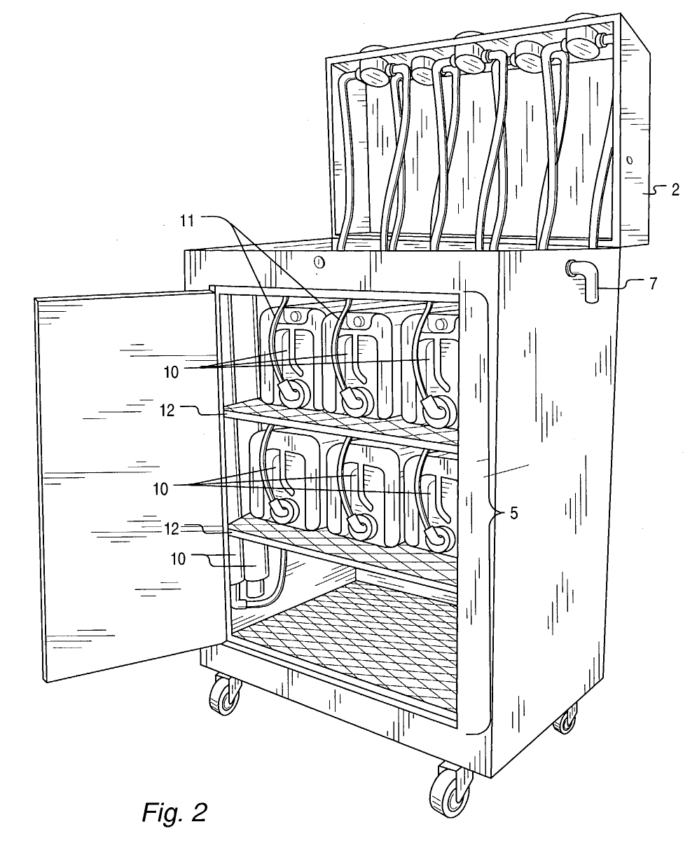

In FIG. 2, top cabinet 2 and main cabinet 5 are shown with open doors. A base fluid may be disposed in container 10. Container 10 may be located in main cabinet 5. Tube 11 may be coupled to container 10 and provide a path for the base fluid to enter top cabinet 2. Tube 11 and container 10 may be made of materials chemically inert with respect to the base fluid. Tube 11 may be made, for example, from rubber, polymeric material, or metal. Tube 11 may be permanently or removably coupled to container 10.

In an embodiment, tube 11 may be made of vinyl tubing. An example of vinyl tubing is Tygon tubing. Container 10 may be made of an inert polymeric material. Containers 10 may be placed on shelves 12. Shelves 12 may be perforated to allow for spilled or leaked fluid to be collected and removed at bottom of main cabinet 5. A perforated shelf may also be used to separate top cabinet 2 from main cabinet 5, which allows for spilled or leaked fluid from the top cabinet to be collected and removed at bottom of the main cabinet. In one embodiment, up to approximately 5 gallons of base fluid may be disposed in container 10. Container 10 may comprise a variety of shapes.

The base fluid may be any fluid used as a component for an automotive appearance care product. The base fluid may be a cleaning agent or a surfactant. Examples of a surfactant may be a nonionic surfactant, a cationic surfactant, a siloxane polymer surfactant, or an organosiloxane polymer surfactant. A nonionic surfactant may include nonylphenol ethoxylates, octylphenol ethoxylates, and ethoxylated alcohols. A cationic surfactant may be, for example, a quaternary ammonium compound. An example of a siloxane polymer surfactant may be dimethylpolysiloxane. A surfactant may also be an anionic surfactant such as a linear alkyl sulfonate.

The base fluid may be a wetting agent. Wetting agents may include fatty acid salts, long chain (between about 12 and 20 carbon atoms) alcohols, or sodium alkyl sulfates. An example of a sodium alkyl sulfate is sodium lauryl sulfate.

The base fluid may be an emulsifier. An emulsifier may be a surface-active agent that reduces interfacial tension between a continuous phase and a dispersed phase in an emulsion. An example of an emulsifier may be coconut fatty acid amide or other alkanolamides.

The base fluid may be a glycol ether. Examples of such compounds are 2-butoxyethanol, propylene glycol monobutyl ether, and dipropylene glycol monobutyl ether.

The base fluid may be an acid. Examples of an acid may be phosphoric, sulfuric, or sulfonic acids. The base fluid may be a glass cleaner. A glass cleaner may be a combination of alcohol, surfactant, and water. The base fluid may also include petroleum distillates, acrylic fluoropolymer resins, aliphatic hydrocarbons, or alcohols. The base fluid may be a foaming agent. In some embodiments, the base fluid may include fragrance or dye.

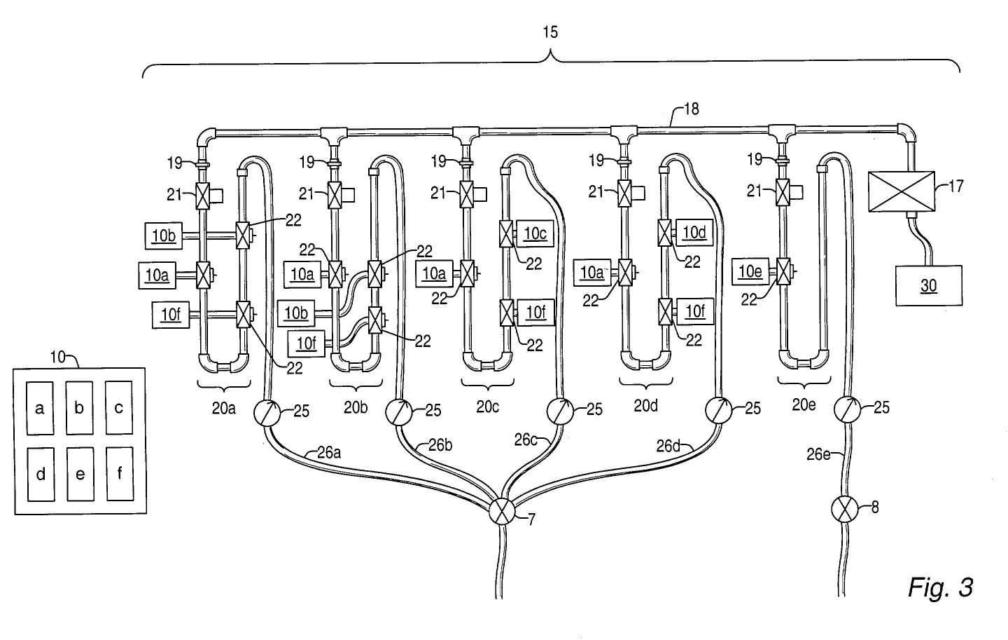

A system for mixing at least one base fluid with the carrier fluid to form an automotive appearance care product fluid may be disposed in top cabinet 2. A schematic for an embodiment of system 15 for injecting at least one base fluid into the carrier fluid to form a plurality of automotive appearance care product fluids is shown in FIG. 3. Supply 30 of carrier fluid (e.g., water) may be coupled to first conduit 18 using methods well known in the art. Using external supply 30 of the carrier fluid may reduce a size of apparatus 1, thus, allowing for a more compact and transportable system. The carrier fluid may be pumped to first conduit 18 using pump 17. Pump 17 may maintain a substantially constant fluid pressure in first conduit 18, regardless of a fluid pressure in supply 30. Thus, apparatus 1 may be moved from one location to another without modifications to the apparatus.

First conduit 18 may include copper tubing with a diameter of about ½ inch. A plurality of supply conduits 20(a-e) may be coupled to first conduit 18 using suitable connectors 19. In the embodiment of FIG. 3, five supply conduits 20(a-e) are coupled to first conduit 18 to provide five product fluids. However, other numbers of supply conduits 20 may be utilized to provide for a different number of product fluids based on a desired use of the dispensing apparatus.

Supply conduit 20 may include valve 21 coupled to first conduit 18. Valve 21 may allow a flow of the carrier fluid from first conduit 18 to supply conduit 20. Valve 21 is, for example, a normally-closed valve. Valve 21 may be operated by switch 3 located outside of top cabinet 2, as depicted in FIG. 1. Each switch 3 may operate a separate valve 21 located in each of supply conduits 20(a-e). Valve 21 may be an electrically-operated solenoid valve or selected from other types of valves such as a pneumatically-operated solenoid valve. An example of valve 21 is an electrically-operated solenoid valve manufactured by DEMA Engineering (St. Louis, Mo.) and widely available through well-known valve distributor companies. Valve 21 may also be operated by a switch controlled by a computer system. If product fluids are chemically compatible, switches 3 may be operated simultaneously to combine product fluids to form a mixture of product fluids dispensed through exit valve 7. Alternatively, switches 3 may be controlled such that a user may not open more than one valve 21 at one time or controlled such that one switch may not be activated during the use of another switch, thereby allowing only one product fluid, or a specific mixture of product fluids, to be dispensed at one time.

Supply conduit 20 may include injector 22. Injector 22 may inject the base fluid into the carrier fluid. Injector 22 may be coupled to container 10 with tube 11 (shown in FIG. 2). Injector 22 may be a single-stage injector that utilizes the flow of carrier fluid to inject the base fluid into the carrier fluid to form the product fluid. An example of injector 22 is an injector manufactured by DEMA Engineering. A flow rate of the carrier fluid through injector 22 may be controlled by the flow rate of carrier fluid through valve 21. The flow rate of carrier fluid through valve 21 may be predetermined by the valve used. Multiple injectors 22 may be used in supply conduit 20 to inject multiple base fluids into the carrier fluid to form a product fluid. In an embodiment, each supply conduit 20(a-e) is used to form one product fluid, respectively. In a supply conduit 20 with multiple injectors 22, each injector may be coupled to a separate container 10.

In an embodiment, each container 10 may be coupled to multiple injectors 22 disposed in separate supply conduits 20(a-e). Each injector may inject a different amount of base fluid into the carrier fluid in each supply conduit. The amount of base fluid injected may be predetermined by a setting of the injector. This may be accomplished with the use of a “T” connector on tube 11 commonly used in the art of plumbing fluid lines. The “T” connector, or more than one “T” connector, may be located in main cabinet 5 (shown in FIG. 2) to divide tube 11 into multiple tubes coupled to multiple injectors 22. This may reduce the number of containers 10 needed in main cabinet 5.

Product fluid may flow through metering device 25 coupled to each supply conduit 20(a-e). Metering device 25 may determine an amount of product fluid dispensed from supply conduit 20 during use of apparatus 1. An example of metering device 25 is a Fill-Rite made by Tuthill Corporation (Burr Ridge, Ill.). The amount of product fluid dispensed may be determined as a total volume in gallons dispensed of product fluid. Metering device 25 may determine a total amount of product fluid dispensed from apparatus 1 during its lifetime, an “odometer” function. Metering device 25 may determine an amount of product fluid dispensed during a single use, or a specific number of uses, a “trip meter” function. In an embodiment, metering device 25 determines both “odometer” and “trip meter” amounts simultaneously and may show either amount on a display or on a computer coupled to the metering device. Monitoring the amount of product fluid dispensed may be used to determine a cost associated with the amount dispensed in order to charge the cost to an end user or other customer.

Supply conduits 20(a-e) may be coupled to at least one exit valve 7 through exit conduits 26(a-e). Exit valve 7 may be used to dispense product to an external container or other such vessel. Coupling to exit valve 7 may be done by methods well known in the art. In some embodiments, a single exit valve 7 is used for product fluids that are chemically compatible. In an embodiment for chemically non-compatible product fluids, one or more additional exit valves may be used. In the embodiment of FIG. 3, two exit valves may be used. A first exit valve 7 may be coupled to first four exit conduits 26(a-d). A second exit valve 8 may be coupled to a fifth exit conduit 26e. The fifth exit conduit 26e may dispense a product fluid chemically non-compatible from product fluids dispensed through the first four exit conduits 26a, 26b, 26c, and 26d. An advantage of the system is the ability to dispense multiple product fluids from a single apparatus regardless of the chemical compatibility of the fluids.

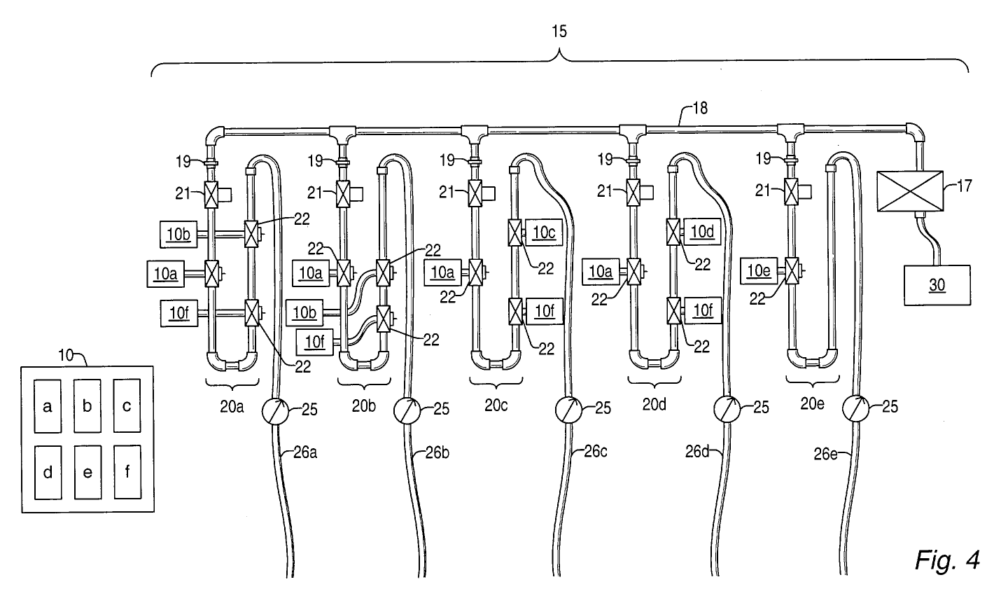

In an embodiment shown in FIG. 4, product fluids may be dispensed through exit conduits 26. Exit conduits 26 may be coupled to a variety of dispensing bodies, e.g., valves or spigots. Exit conduits 26 may be coupled to one or more dispensing bodies, or any combination thereof. A number and configuration of exit conduits 26 and dispensing bodies may be determined by a desired use of the system.

Product fluids may be used as automotive appearance care products. Examples of such products are degreasers, all-purpose automotive cleaners, car wash soaps, wheel cleaners, glass cleaners, dressing fluids, or other substantially similar products that may be used in automotive appearance care. Further examples of product fluids include quick detail sprays, clay lubricants, and fabric or carpet cleaners. Some product fluids may include Auto Magic® products such as Motor Degreaser, Red Hot®, Glass Cleaner Concentrate, Enzyme Pre-spot, XP Citrus Wheel Cleaner™, Special Cleaner Conc.™, and Super Dress-It®. The system may be used to dispense product fluids that are concentrated fluids needing further dilution before use. The system may also dilute the product fluids and dispense product fluids that are ready for immediate use by a consumer.

In an embodiment, the system may be used to dispense automotive appearance care products that are used in a high volume area. For example, a system for dispensing a plurality of product fluids may be used for processing approximately 150 to approximately 250 automobiles per day. Such a high volume location may be, for example, at an automobile auction. Products similar to those used in automotive appearance care may possibly be dispensed from a system used according to embodiments described herein.

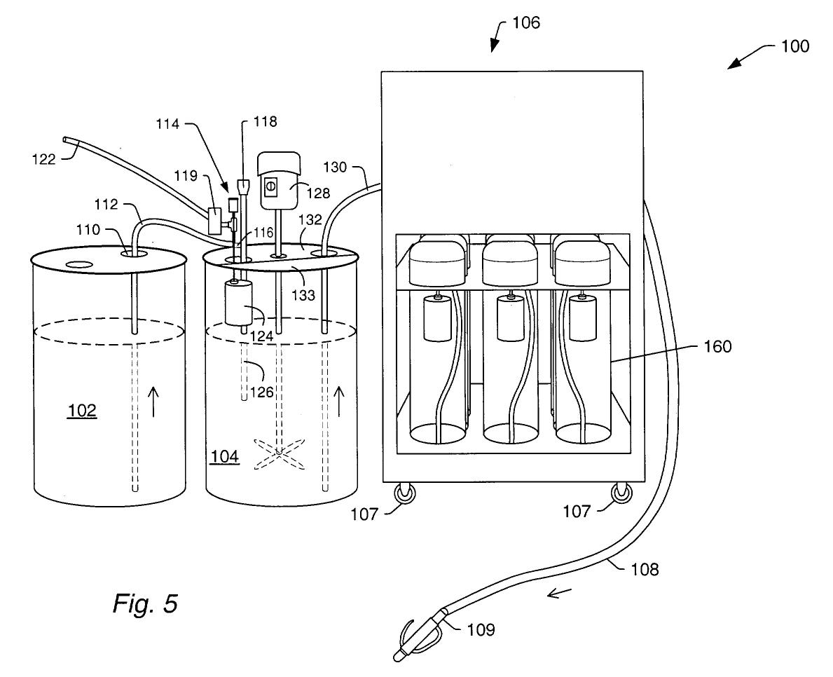

FIG. 5 depicts an embodiment of system 100 that may be used to dispense a plurality of automotive appearance care products. The system may have a plurality of storage containers 102 coupled to a plurality of mixing containers 104. Mixing containers 104 may be coupled to dispensing apparatus 106. Automotive appearance care products may be dispensed through one or more dispensing conduits 108. For clarity in the drawing, only one storage container 102, mixing container 104, and dispensing conduit 108 are shown. It is to be understood that any number of storage containers, mixing containers, and dispensing conduits may be used as described herein. In certain embodiments, the number of storage containers used is the same as the number of mixing containers used, with each storage container coupled to a single mixing container. For example, nine storage containers may be used with nine mixing containers.

Storage container 102 may contain a raw material. The raw material may include materials used as a base material for producing an automotive appearance care product. For example, the raw material may include a liquid concentrate of an automotive appearance care product. In an embodiment, storage container 102 is a 55 gallon drum containing a liquid concentrate. Storage container 102 may have opening 110. Conduit 112 may be placed in opening 110 and coupled to mixing container 104. In an embodiment, conduit 112 allows raw material to flow from storage container 102 to mixing container 104. In some embodiments, storage container 102 may be coupled to more than one mixing container 104 with one or more conduits (i.e., one storage container 102 may supply raw material to more than one mixing container 104). Conduit 112 may extend proximate bottom of storage container 102. Conduit 112 may include materials chemically inert to the liquid concentrate such as, but not limited to, PVC or polyethylene.

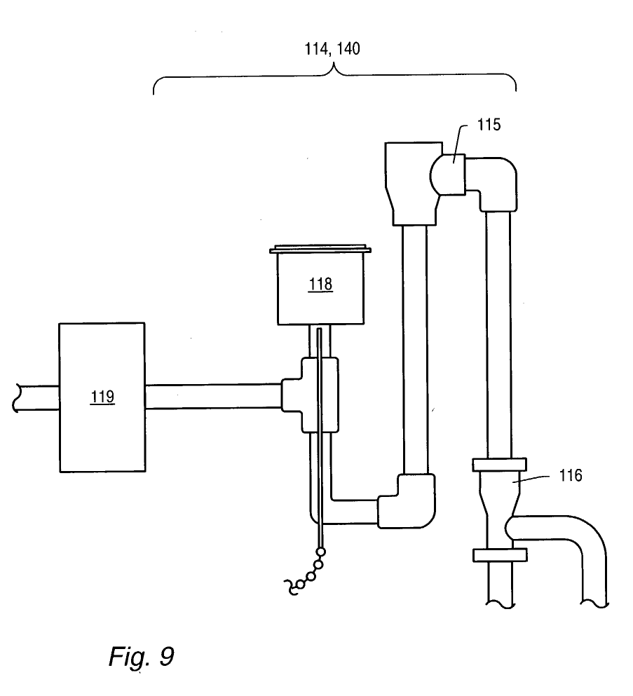

Conduit 112 may be coupled to mixing system 114. Mixing system 114 may be coupled to mixing container 104. Mixing system 114 may be placed at or in an opening in cover 132 of mixing container 104. Mixing system 114 may include body 115, valve 118, mixing valve 116, and float 124, as depicted in FIG. 9. Mixing system 114 may be a single unit obtainable from Hydro Systems Co. (Cincinnati, Ohio). In an embodiment, mixing system is a Hydro Systems Co. HydroMinder Series Model 515. Valve 118 may be coupled to carrier fluid supply conduit 122. Valve 118 may be a magnetically operated valve. Carrier fluid supply conduit 122 may be further coupled to a carrier fluid supply. The carrier fluid supply may include a localized source of carrier fluid. For example, the carrier fluid supply may be a faucet, a tank, or a reservoir. In an embodiment, the carrier fluid is water.

When valve 118 is opened, carrier fluid may enter body 115 of mixing system 114 through valve 1 18. The carrier fluid may flow through mixing valve 116. Mixing valve 116 may be, for example, a venturi valve. In some embodiments, mixing valve 116 may include an injector.. Mixing valve 116 may be used to combine carrier fluid with raw material from storage container 102. In an embodiment, when carrier fluid flows through mixing system 114, mixing valve 116 siphons fluid from conduit 112. This siphoning may produce a flow of raw material through conduit 112. The raw material may be combined with carrier fluid in mixing valve 116. A proportion of raw material to carrier fluid produced by mixing valve 116 may be determined by a design of the mixing valve. The combined raw material and carrier fluid may flow through mixing valve 116 and to mixing container 104. Conduit 126 may be coupled to mixing system 114 to provide the combined raw material and carrier fluid to mixing container 104. Mixing system 114 may include float 124. Float 124 may rise and fall with a level of fluid in mixing container 104. Float 124 may be used to turn on and/or off mixing system 114. The status (on or off) of mixing system 114 may be controlled by operation (i.e., opening or closing) of valve 118. A position of float 124 may cause valve 118 to open or close. In an embodiment, valve 118 is opened when float 124 falls below a lower specified height. Valve 118 may be closed when float 124 rises above an upper specified height.

Valve 119 may be coupled between valve 118 of mixing system 114 and carrier fluid supply conduit 122. Valve 119 may be a solenoid valve. Valve 119 may be either electrically or pneumatically operated. In an embodiment, valve 119 is a normally-closed solenoid valve. Valve 119 may be used to control the flow of carrier fluid between carrier fluid supply conduit 122 and mixing system 114. Closing valve 119 may inhibit the flow of carrier fluid to mixing system 114. Valve 119 may be operated by a switch. The switch may be controlled by a user or, in some embodiments, may be automatically controlled (e.g., by a computer or a timing device).

In some embodiments, a powder may be added to mixing container 104. Mixing container 104 may include cover 132 with lid 133. Lid 133 may be opened to allow for adding of a powder to mixing container 104. The powder may include a base material for producing an automotive appearance care product. An example of powder may include, but not be limited to, caustic soda. In some embodiments, powder may be added to mixing container 104 while valve 118 is open. In an embodiment, powder may be automatically added to mixing container 104 at a specified time. Powder may be added using an automated dispensing system. The automated dispensing system may be coupled (e.g., interlocked) with mixing system 114 to provide powder to mixing container 104 substantially simultaneously with carrier fluid and raw material dispensed by mixing system 114. Mixing container 104 may include materials substantially inert to carrier fluid, raw material, powder, and any combination thereof. For example, mixing container 104 may be a cylindrical polyethylene container obtainable from Chem-Tainer Industries (West Babylon, N.Y.).

Mixer 128 may be placed in mixing container 104. Mixer 128 may be a stirrer. For example, mixer 128 may be a four-bladed stirrer as shown in FIG. 5. Mixer 128 may be used to mix contents of mixing container 104 into a mixture. In an embodiment, mixer 128 is used to produce a mixture of raw material, carrier fluid, and powder in the mixing container.

In an embodiment, mixer 128 may be turned on and valve 119 opened substantially simultaneously. A switch may be used to provide power to mixer 128 and open valve 119 at substantially the same time. In certain embodiments, valve 119 is a solenoid valve that opens when power is applied to the valve (e.g., a normally-closed solenoid valve). In some embodiments, the switch may be coupled (e.g., interlocked) to float 124 such that power is not provided to valve 118 or mixer 128 until the float is above a specified height in mixing container 104. Mixer 128 and valve 119 may also be placed on a timing device (e.g., a clock timer) such that they operate for a specified time. In some embodiments, the timing device may be included in a switch. For example, the timing device may be set so that power is provided to mixer 128 and valve 119 for approximately 30 minutes or, in some embodiments, a time between about 20 minutes and about 40 minutes. The specified time may be determined by a time needed for substantially complete mixing of the contents of mixing container 104.

In some embodiments, float 124 may reach a specified height in mixing container 104, thus closing valve 118 in mixing system 114 before the timing device turns off power to mixer 128 and valve 119. For example, the specified height in the mixing container may be reached after a time less than the specified time of the timing device (e.g., about 10 minutes) while mixer 128 will run and valve 119 will be open for the specified time (e.g., about 30 minutes). In other embodiments, mixer 128 and valve 119 may be separately controlled by one or more timing devices. Using the mixer for a period of time after filling the mixing container may produce a more uniform mixture in the mixing container and, thus, a better product quality. In an embodiment, after the timing device turns off power to mixer 128 and valve 119, the flow of carrier fluid through valve 119 and to mixing system 114 may be reduced or stopped to inhibit unnecessary filling of mixing container 104. For example, inhibiting flow of carrier fluid through valve 119 may inhibit automatic filling of mixing container 104 with carrier fluid and raw material without adding powder to the mixing container (i.e., mixing container 104 cannot be filled with raw material and carrier fluid if float 124 opens valve 118 in mixing system 114 because there is no flow of carrier fluid through valve 119). Controlling the flow of carrier fluid may also allow for control of the production of a mixture in a mixing container so that the mixture cannot be produced until a mixing container is substantially empty.

In some embodiments, contents of mixing container 104 may substantially mix without using mixer 128 (e.g., if the mixture contains only raw material and carrier fluid). The raw material and carrier fluid may be substantially mixed by mixing system 114. In such a case, a timing device or switch may be used to open and close valve 119 to control the flow of carrier fluid as described herein.

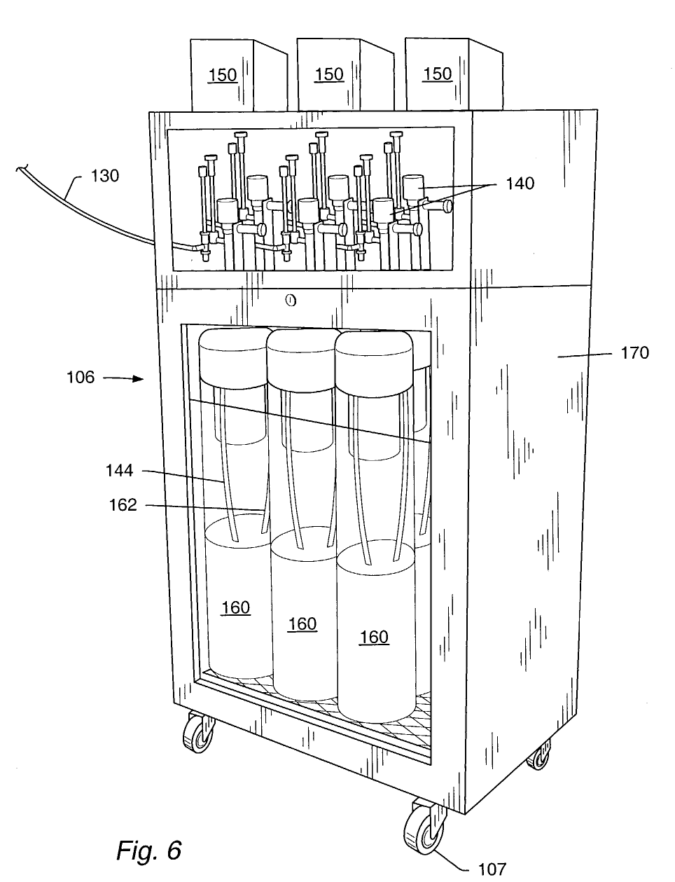

As shown in FIG. 5, mixing container 104 may be coupled to dispensing apparatus 106 by conduit 130. FIG. 6 depicts an embodiment of dispensing apparatus 106. Conduit 130 may be coupled to mixing system 140 in dispensing apparatus 106. Mixing system 140 may be similar to the embodiment of mixing system 114, as depicted in FIG. 9. In an embodiment, mixing system 140 is a Hydro Systems Co. HydroMinder Series Model 515.

One or more mixing systems 140 may be placed in an upper portion of dispensing apparatus 106 as shown in FIG. 6. However, a location of mixing system 140 may vary. In some embodiments, nine mixing systems may be placed in dispensing apparatus 106. Typically, a number of mixing systems may be equal to a number of mixing containers and storage containers with each mixing system coupled to one mixing container. However, mixing container 104, in some embodiments, may be coupled to more than one mixing system 140. One or more storage vessels 160 may be placed in a lower portion of dispensing apparatus 106. Each storage vessel 160 may be coupled to a mixing system 140 with conduit 144. In some embodiments, additional mixing systems may be coupled to each storage vessel 160. Additional mixing systems may be used to provide more than one mixture (e.g., mixtures from two or more mixing containers 104) to each storage vessel 160. Conduit 144 may substantially extend into a lower portion of storage vessel 160.

One or more pumps 150 may be placed in an upper portion of dispensing apparatus 106 above mixing systems 140. However, a location of pumps 150 may vary in dispensing apparatus 106. Each pump 150 may be coupled to a storage vessel 160 with conduit 162. In an embodiment, one pump 150 is coupled to each storage vessel 160, which is coupled to each mixing system 140. Thus, a number of pumps may typically be equal to a number of storage vessels and a number of mixing systems.

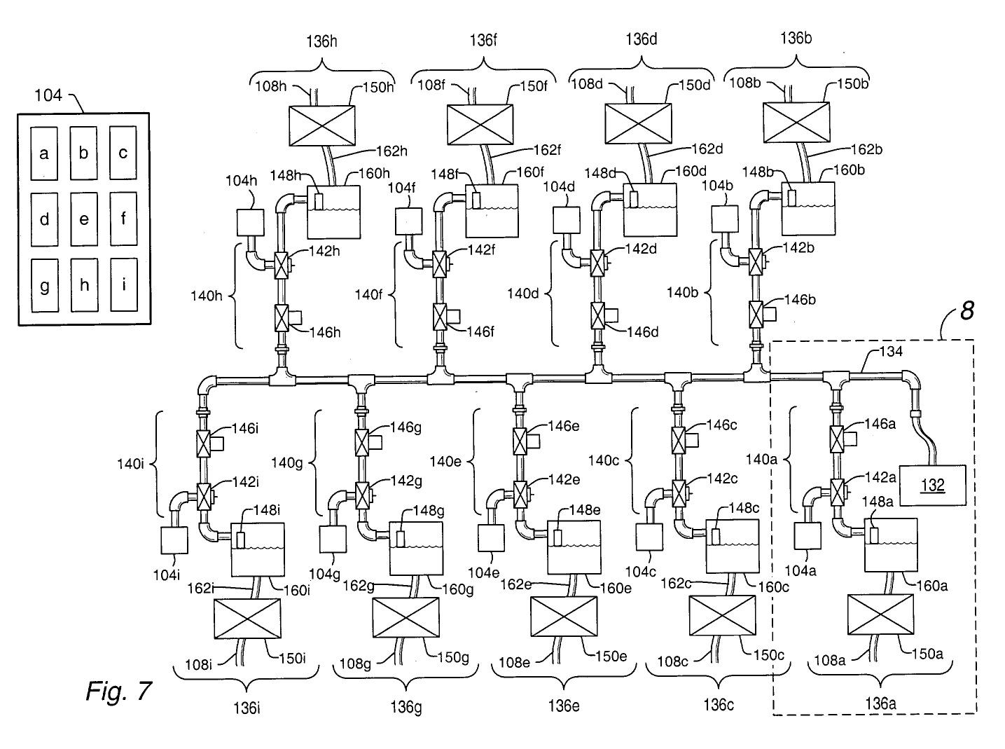

FIG. 7 illustrates a schematic of an embodiment of dispensing apparatus 106. FIG. 7 illustrates an embodiment with nine supply systems 136(a-i) branched from carrier fluid supply conduit 134. However, a number of supply systems may be varied depending on, for example, a desired use of dispensing apparatus 106. Carrier fluid supply 132 may be coupled to carrier fluid supply conduit 134. Carrier fluid supply 132 may be located outside of dispensing apparatus 106. For example, carrier fluid supply 132 may be a faucet, a tank, or a reservoir. Carrier fluid supply conduit 134 may be branched so as to couple to each supply system 136(a-i). Mixing containers 104(a-i) may be coupled to each respective supply system 136(a-i) (i.e., mixing container 104a is coupled to supply system 136a, mixing container 104b is coupled to supply system 136b, etc.). However, in certain embodiments, a mixing container may be coupled to more than one supply system. In some embodiments, more than one mixing container may be coupled to a single supply system. Thus, two or more mixtures produced in the mixing containers may be combined in the single supply system.

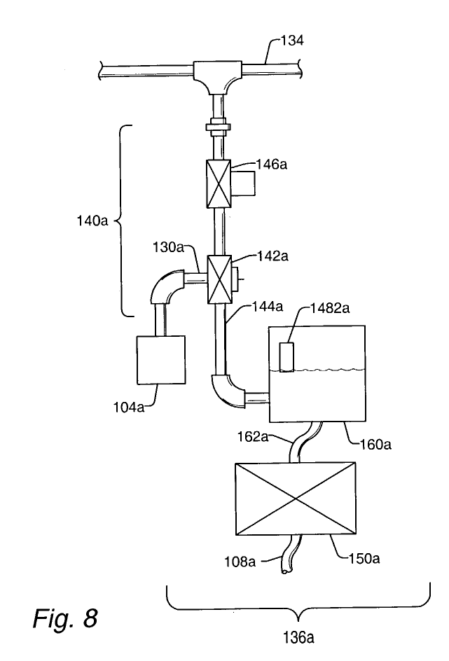

FIG. 8 illustrates a schematic of an embodiment of supply system 136a branched from carrier fluid supply conduit 134. Each of supply systems 136(a-i) shown in FIG. 7 may include elements substantially similar to the supply system described in the embodiment of FIG. 8.

As shown in FIG. 8, a branch of carrier fluid supply conduit 134 may be coupled to valve 146a in mixing system 140a. Valve 146a may be a magnetically operated valve obtained as part of mixing system 140a. Valve 146a may be similar to the embodiment of valve 118 as described above. For example, valve 146a may be a venturi valve. Opening and closing of valve 146a may be controlled by a level of float 148a placed in storage vessel 160a. Float 148a may rise and fall with a level of fluid in storage vessel 160a. Valve 146a may be opened when float 148a falls below a lower specified height in storage vessel 160a. Valve 146a may close when float 148a rises above an upper specified height in storage vessel 160a. Valve 146a typically remains closed until float 148a falls below the lower specified height. This process may automatically open and close valve 146a based on a level of float 148a in storage vessel 160a. Thus, an automatic re-filling process for storage vessel 160a may be provided.

When valve 146a is opened, carrier fluid may flow through mixing system 140a and through mixing valve 142a. Mixing valve 142a may be similar to the embodiment of mixing valve 116. Carrier fluid flowing through mixing valve 142a siphons fluid from conduit 130a, thus, providing a flow of the mixture from mixing container 104a through the mixing valve and to storage vessel 160a. Mixing container 104a may be a mixing container coupled to supply system 136a. The mixture may be combined with carrier fluid in mixing valve 142a to produce a product fluid. A proportion of mixture to carrier fluid produced by mixing valve 142a may be determined by a design of the mixing valve. The product fluid may flow through mixing valve 142a and to storage vessel 160a. Conduit 144a may be coupled to mixing system 140a to provide the product fluid to storage vessel 160a. Conduit 144a may substantially extend into storage vessel 160a. Storage vessel 160a may include materials that are substantially chemically inert to product fluid(s). For example, storage vessel 160a may include polymeric materials such as polyethylene.

Conduit 162a may substantially extend into storage vessel 160a proximate a bottom of the storage vessel. Conduit 162a may couple storage vessel 160a to pump 150a. Any of the conduits described herein (e.g., conduit 162a, conduit 130, conduit 144a, etc.) may include, but not be limited to, substantially chemically inert materials such as polyethylene, PVC, etc.

Pump 150a may be used to pump product fluid from storage vessel 160a to dispensing conduit 108a. Pump 150a may be any pump that provides a pressure of product fluid to dispensing conduit 108a. In an embodiment, pump 150a is a diaphragm pump. For example, pump 150a may be an air-operated ARO ¼″ non-metallic diaphragm pump available from Ingersoll Rand Co. (Woodcliff Lake, N.J.). Air may be supplied to pump 150a through an air supply conduit located in dispensing apparatus 106. The air supply conduit may include a central conduit with branches coupled to each pump 150(a-i) in dispensing apparatus 106. Pump 150a may be turned on by a user of dispensing apparatus 106. In some embodiments, pump 150a may be turned on by a switch located on dispensing apparatus 106. In other embodiments, pump 150a (and pumps 150(b-i)) may run continuously with power supplied to dispensing apparatus 106.

Dispensing conduit 108a may be coupled to an outlet port of pump 150a. Fluid applicator 109 may be coupled to an end of dispensing conduit 108a (as shown in FIG. 5). Fluid applicator 109 may be coupled (e.g., interlocked) to turn on pump 150a when the fluid applicator is used. Fluid applicator 109 may be a sprayer. In some embodiments, one or more additional dispensing conduits may be coupled to dispensing conduit 108a. In certain embodiments, a metering device (e.g., a metering device as described in the embodiment of FIG. 1) may be coupled to dispensing conduit 108a. The metering device may be used to determine an amount of product fluid dispensed. The amount of product fluid dispensed may be used to determine a cost for charging a customer using system 100.

In certain embodiments, a cost charged to a user may be assessed, or determined, based on the number of automobiles, or vehicles, that are treated, or will be treated, with fluids provided by an automotive appearance care product dispensing system. The user may be charged on a cost per vehicle treated basis for use of the automotive appearance care product dispensing system. The cost per vehicle treated may be based on a set rate. The set rate may be based on the average amount of fluids needed, which may be estimated or predetermined, for each vehicle treated with automotive appearance care product fluids. The set rate may include other costs such as chemical or material costs, freight costs, labor costs, etc. In some embodiments, the set rate may be adjusted for each vehicle based on certain variables such as, but not limited to, a size of a vehicle (e.g., compact, mid-size, full-size, etc.), the vehicle manufacturer, and/or the vehicle model. The average amount of product fluids to be used for treating a vehicle may change based on these variables (e.g., a full-size vehicle may require more fluids than a compact vehicle). Thus, the set rate for treating a certain type of vehicle may be adjusted accordingly.

In an embodiment, the cost charged to a user may be assessed, or determined, as the set rate multiplied by the number of vehicles treated by the user with one or more automotive appearance care products. The set rate may be assessed (e.g., predetermined) for the user before the user utilizes the automotive appearance care product dispensing system. The set rate may be assessed or determined by a manufacturer of the dispensing system, and/or a supplier of the automotive appearance care products and/or base materials for the automotive appearance care products. In certain embodiments, the manufacturer of the dispensing system may also be the supplier of the automotive appearance care products or base materials for the automotive appearance care products.

In some embodiments, a set rate may be assessed or determined for each individual automotive appearance care product. Individual set rates for each automotive appearance care product may be used in combination to determine a cost to be charged to a user of the dispensing system. Individual set rates may be used, for example, when certain automotive appearance care products are not used for certain types of vehicles. As another example, some automotive appearance care products may be used at one location for using the dispensing system but not at a second location for using the dispensing system. Thus, the set rate may be adjusted between locations based on which automotive appearance care products will be used at each location.

Charging a cost to the user based on a set rate, or, in some embodiments, on more than one set rate, may reduce the number of costs a user of an automotive appearance care product dispensing system has to track and/or monitor during use. The user may only have to budget for the number and/or type of automobiles processed since costs such as chemical or material costs, freight costs, labor costs, etc., have already been factored into the set rate for each vehicle processed. The user may not need to budget separately for these other types of costs, thereby simplifying bookkeeping, inventory, and/or other tasks associated with monitoring, tracking, or budgeting. This simplification may allow a user to operate a business (e.g., a vehicle auction) or process more efficiently.

In some embodiments, dispensing of the automotive appearance care products may be substantially automated. Automatically dispensing products may reduce excess use of materials or fluids by a user of the system. Automatically dispensing products may further simplify operation of the dispensing system and the business or process utilizing the dispensing system.

As shown in FIG. 6, dispensing apparatus 106 may be placed in cabinet 170. Cabinet 170 may include wheels 107. Cabinet 170 may be transportable. Dispensing apparatus 106 may be removably coupled to mixing container 104 so that dispensing apparatus 106 may be more easily transported and/or replaced if necessary. Dispensing apparatus 106 may be enclosed in cabinet 170 such that a user of the system cannot access the dispensing apparatus. User access may be restricted to on/off operation of dispensing apparatus 106. In certain embodiments, a user of the system may be limited to operating a switch that turns on a system to produce and dispense product fluids and/or to dispensing the product fluids by operating a fluid applicator or dispensing valve.

Using the embodiment in FIG. 3, five automotive appearance care product fluids were dispensed by system 15. Six different base fluids were disposed in containers 10. A surfactant was disposed in container 10a. A first cleaning agent was disposed in container 10b. A foaming agent was disposed in container 10c. A second cleaning agent was disposed in container 10d. A glass cleaner was disposed in container 10e. A fragrance was disposed in container 10f. Water was supplied as the carrier fluid from an external faucet source.

A degreaser was produced in supply conduit 20a. The degreaser was formed by injection of surfactant from 10a, first cleaning agent from 10b, and fragrance from 10f into the water flowing from first conduit 18. Each injector 22 injected a predetermined amount of each base fluid (surfactant, first cleaning agent, or fragrance) into the flow of water. Injectors 22 were injectors manufactured by DEMA Engineering. Solenoid valve 21 controlled a flow rate of water from first conduit 18 to supply conduit 20a. An amount of degreaser dispensed was determined with metering device 25. Metering device 25 was a Fill-Rite from Tuthill Corporation. The degreaser was dispensed through exit valve 7.

Supply conduits 20(b-d) operated in a similar manner producing different product fluids. An all-purpose cleaner was produced in supply conduit 20b from the injection of surfactant from 10a, first cleaning agent from lob, and fragrance from 10f. A greater flow rate of water from first conduit 18 produced an all-purpose cleaner that was more diluted than the degreaser made from the same base fluids in supply conduit 20a.

Supply conduit 20c used surfactant from 10a, foaming agent from 10c, and fragrance from 10f to form car wash soap. Supply conduit 20d used surfactant from 10a, second cleaning agent from 10d, and fragrance from 10f to form a wheel cleaner. All product fluids formed in supply conduits 20(a-d) were dispensed through exit valve 7. These product fluids were dispensed through the same valve 7 because of their chemical compatibility. The product fluids were dispensed at separate times through use of switches 3 on top panel 2. No system cleanup was necessary between dispensing of these fluids, although a brief initial dispensing period was beneficial to clean out fluid from the previous dispensing period. Metering devices 25 monitored a volume dispensed for each use and a total volume dispensed over time for each product fluid.

Supply conduit 20e used glass cleaner from container 10c injected into the water to form a more dilute glass cleaner. The glass cleaner was chemically non-compatible with fluids formed in supply conduits 20(a-d) and therefore was dispensed through separate exit valve 8. Metering device 25 coupled to supply conduit 20e monitored a volume of glass cleaner dispensed.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

What is claimed is:

1. A system configured to dispense a plurality of automotive appearance care products, comprising:
a plurality of base fluids disposed in containers;
a first conduit configured to transport a carrier fluid, wherein the first conduit is coupled to a carrier fluid supply; and
a plurality of supply conduits coupled to the first conduit, each supply conduit, comprising:
at least one injector, wherein the injector is further coupled to at least one base fluid container with a second conduit, and wherein the at least one injector is configured to inject the base fluid into the carrier fluid to form a product fluid during use.

2. The system of claim 1, wherein the plurality of base fluid containers comprises a material substantially chemically inert with respect to the base fluid.

3. The system of claim 1, wherein the plurality of base fluid containers comprises a plurality of polymeric material containers.

4. The system of claim 1, wherein the base fluid comprises cleaning agent.

5. The system of claim 1,,wherein the base fluid comprises surfactant.

6. The system of claim 1, wherein the base fluid comprises nonionic surfactant.

7. The system of claim 1, wherein the base fluid comprises nonylphenol ethoxylate.

8. The system of claim 1, wherein the base fluid comprises octyl phenol ethoxylate.

9. The system of claim 1, wherein the base fluid comprises alkanolamide compound.

10. The system of claim 1, wherein the base fluid comprises cationic surfactant.

11. The system of claim 1, wherein the base fluid comprises quaternary ammonium compound.

12. The system of claim 1, wherein the base fluid comprises silicone surfactant.

13. The system of claim 1, wherein the base fluid comprises organosilicone surfactant.

14. The system of claim 1, wherein the base fluid comprises wetting agent.

15. The system of claim 1, wherein the base fluid comprises sodium lauryl sulfate.

16. The system of claim 1, wherein the base fluid comprises foaming agent.

17. The system of claim 1, wherein the base fluid comprises glass cleaner.

18. The system of claim 1, wherein the base fluid comprises emulsifier.

19. The system of claim 1, wherein the base fluid comprises ether compound.

20. The system of claim 1, wherein the base fluid comprises glycerol.

21. The system of claim 1, wherein the base fluid comprises glycol ether.

22. The system of claim 1, wherein the base fluid comprises 2-butoxyethanol.

23. The system of claim 1, wherein the base fluid comprises propylene glycol monobutyl ether.

24. The system of claim 1, wherein the base fluid comprises dipropylene glycol monobutyl ether.

25. The system of claim 1, wherein the base fluid comprises silicone fluid.

26. The system of claim 1, wherein the base fluid comprises acid.

27. The system of claim 1, wherein the base fluid comprises fragrance.

28. The system of claim 1, wherein the base fluid comprises dye.

29. The system of claim 1, wherein the base fluid comprises a component of an automotive appearance care product.

30. The system of claim 1, wherein the carrier fluid supply is disposed external to the system.

31. The system of claim 1, wherein the carrier fluid comprises water.

32. The system of claim 1, further comprising a pump coupled to the carrier fluid supply and the first conduit, wherein the pump is configured to increase a pressure of the carrier fluid during use.

33. The system of claim 1, wherein the first conduit comprises copper tubing.

34. The system of claim 1, further comprising at least one valve coupled to the first conduit, wherein at least the one valve is configured to allow a flow of the carrier fluid from the first conduit to one of the plurality of supply conduits during use.

35. The system of claim 34, wherein at least the one valve coupled to the first conduit comprises a normally-closed valve.

36. The system of claim 34, wherein at least the one valve coupled to the first conduit comprises a solenoid valve.

37. The system of claim 34, wherein at least the one valve coupled to the first conduit comprises a solenoid valve, and wherein the solenoid valve is configured to produce a predetermined flow rate of carrier fluid during use.

38. The system of claim 34, wherein at least the one valve coupled to the first conduit comprises a solenoid valve, and wherein the solenoid valve is operated electrically.

39. The system of claim 34, wherein at least the one valve coupled to the first conduit comprises a solenoid valve, and wherein the solenoid valve is operated pneumatically.

40. The system of claim 34, wherein at least the one valve coupled to the first conduit comprises a solenoid valve, and wherein operation of the solenoid valve is controlled by a switch during use.

41. The system of claim 34, wherein at least the one valve coupled to the first conduit comprises a solenoid valve, wherein operation of the solenoid valve is controlled by a switch, and wherein the switch is operated by a user of the system during use.

42. The system of claim 34, wherein at least the one valve coupled to the first conduit comprises a solenoid valve, wherein operation of the solenoid valve is controlled by a switch, and wherein the switch is controlled by a computer during use.

43. The system of claim 34, wherein at least the one valve coupled to the first conduit comprises a solenoid valve, wherein operation of the solenoid valve is controlled by a switch, and wherein an amount of product fluid dispensed is controlled by the operation of the switch during use.

44. The system of claim 1, wherein the at least one injector comprises a single-stage injector.

45. The system of claim 1, wherein each of the plurality of supply conduits comprises at least one material substantially chemically inert with respect to the base fluid.

46. The system of claim 1, wherein each of the plurality of supply conduits comprises polyvinyl chloride (PVC).

47. The system of claim 1, wherein each of the second conduits comprises material substantially chemically inert with respect to the base fluid.

48. The system of claim 1, further comprising a metering device coupled to each of the plurality of supply conduits, wherein the metering device is configured to determine an amount of product fluid dispensed during use.

49. The system of claim 1, further comprising at least one exit valve coupled to each of the plurality of supply conduits, wherein the at least one exit valve is configured to dispense at least one product fluid during use.

50. The system of claim 1, wherein the system is configured to dispense a plurality of product fluids during use.

51. The system of claim 1, wherein the product fluid comprises degreaser.

52. The system of claim 1, wherein the product fluid comprises all-purpose automotive cleaner.

53. The system of claim 1, wherein the product fluid comprises car wash soap.

54. The system of claim 1, wherein the product fluid comprises wheel cleaner.

55. The system of claim 1, wherein the product fluid comprises glass cleaner.

56. The system of claim 1, wherein the product fluid comprises dressing fluid.

57. The system of claim 1, wherein the product fluid comprise automotive appearance care product.

58. The system of claim 1, wherein the product fluid comprises concentrated fluid.

59. The system of claim 1, wherein the product fluid comprises fluid configured to be ready to use.

60. The system of claim 1, wherein the system is configured in a transportable arrangement.

61. A method for dispensing a plurality of automotive appearance care products, comprising:
supplying a carrier fluid to a plurality of supply conduits;
injecting at least one base fluid into the carrier fluid in each of the plurality of supply conduits to form a plurality of product fluids; and
dispensing the plurality of product fluids.

62. The method of claim 61, wherein at least the one base fluid is placed in a container.

63. The method of claim 61, wherein the carrier fluid comprises water.

64. The method of claim 61, further comprising increasing a pressure of the carrier fluid using a pump.

65. The method of claim 61, further comprising controlling a flow rate of the carrier fluid with at least one valve.

66. The method of claim 61, further comprising controlling a flow rate of the carrier fluid with at least one valve, wherein the flow rate is predetermined.

67. The method of claim 61, further comprising controlling a flow of the carrier fluid with at least one valve, wherein the valve is controlled by a switch.

68. The method of claim 61, further comprising controlling a flow of the carrier fluid with at least one valve, wherein the valve is controlled by a switch, and wherein the switch is operated by a user of a system.

69. The method of claim 61, further comprising controlling a flow of the carrier fluid with at least one valve, wherein the valve is controlled by a switch, and wherein the switch is operated by a computer.

70. The method of claim 61, further comprising controlling a flow of the carrier fluid with at least one valve, wherein the valve is controlled by a switch, and wherein an amount of each of the plurality of product fluids dispensed is controlled by operation of the switch.

71. The method of claim 61, further comprising dispensing each of the plurality of product fluids through at least one exit valve.

72. The method of claim 61, further comprising determining a volume of each of the plurality of product fluids dispensed.

73. The method of claim 61, further comprising determining a volume of each of the plurality of product fluids dispensed, wherein the volume is determined using a metering device.

74. The method of claim 61, further comprising dispensing the plurality of product fluids in a transportable system.

75. A system configured to dispense an automotive appearance care product, comprising:
a surfactant disposed in a first container;
a cleaning agent disposed in a second container;
a first conduit configured to transport a carrier fluid, wherein the first conduit is coupled to a carrier fluid supply; and
a supply conduit coupled to the first conduit, the supply conduit, comprising:
a first injector, wherein the first injector is further coupled to the first container with a second conduit, and wherein the first injector is configured to inject the surfactant into the carrier fluid to form a product fluid during use;
a second injector, wherein the second injector is further coupled to the second container with a third conduit, and wherein the second injector is configured to inject the cleaning agent into the carrier fluid to form a product fluid during use.

76. The system of claim 75, wherein the surfactant comprises nonionic surfactant.

77. The system of claim 75, wherein the surfactant comprises cationic surfactant.

78. The system of claim 75, wherein the surfactant comprises silicone surfactant.

79. The system of claim 75, wherein the surfactant comprises organosilicone surfactant.

80. The system of claim 75, wherein the carrier fluid supply is disposed external to the system.

81. The system of claim 79, wherein the carrier fluid comprises water.

82. The system of claim 75, further comprising a pump coupled to the carrier fluid supply and the first conduit, wherein the pump is configured to increase a pressure of the carrier fluid during use.

83. The system of claim 75, wherein the first conduit comprises copper tubing.

84. The system of claim 75, further comprising a valve coupled to the first conduit, wherein the valve is configured to allow a flow of the carrier fluid from the first conduit to the supply conduit during use.

85. The system of claim 84, wherein at least the one valve coupled to the first conduit comprises a solenoid valve.

86. The system of claim 75, further comprising a metering device coupled to the supply conduit, wherein the metering device is configured to determine an amount of product fluid dispensed during use.

87. The system of claim 75, further comprising at least one exit valve coupled to the supply conduit, wherein the at least one exit valve is configured to dispense the product fluid during use.

88. The system of claim 75, wherein the product fluid comprises degreaser.

89. The system of claim 75, wherein the product fluid comprises all purpose cleaner.

90. The system of claim 79, wherein the product fluid comprise automotive appearance care product.

91. A method for dispensing an automotive appearance care product, comprising:
supplying a carrier fluid to a supply conduit;
injecting a surfactant and a cleaning agent into the carrier fluid in the supply conduit to form a product fluid; and
dispensing the product fluid.

92. The method of claim 91, wherein the carrier fluid comprises water.

93. The method of claim 91, further comprising increasing a pressure of the carrier fluid using a pump.

94. The method of claim 91, further comprising controlling a flow rate of the carrier fluid with at least one valve.

95. The method of claim 91, further comprising controlling a flow rate of the carrier fluid with at least one valve, wherein the flow rate is predetermined.

96. The method of claim 91, further comprising controlling a flow of the carrier fluid with at least one valve, wherein the valve is controlled by a switch.

97. The method of claim 91, further comprising controlling a flow of the carrier fluid with at least one valve, wherein the valve is controlled by a switch, and wherein the switch is operated by a user of a system.

98. The method of claim 91, further comprising controlling a flow of the carrier fluid with at least one valve, wherein the valve is controlled by a switch, and wherein the switch is operated by a computer.

99. The method of claim 91, further comprising controlling a flow of the carrier fluid with at least one valve, wherein the valve is controlled by a switch, and wherein an amount of the product fluid dispensed is controlled by operation of the switch.

100. The method of claim 91, further comprising dispensing the product fluid through at least one exit valve.

101. The method of claim 91, further comprising determining a volume of the product fluid dispensed.

102. The method of claim 91, further comprising determining a volume of the product fluid dispensed, wherein the volume is determined using a metering device.

103. The method of claim 91, further comprising dispensing the plurality of product fluids in a transportable system.

104. A system configured to dispense an automotive appearance care product, comprising:
a surfactant disposed in a first container;
a foaming agent disposed in a second container;
a first conduit configured to transport a carrier fluid, wherein the first conduit is coupled to a carrier fluid supply; and
a supply conduit coupled to the first conduit, the supply conduit, comprising:
a first injector, wherein the first injector is further coupled to the first container with a second conduit, and wherein the first injector is configured to inject the surfactant into the carrier fluid to form a product fluid during use;
a second injector, wherein the second injector is further coupled to the second container with a third conduit, and wherein the second injector is configured to inject the foaming agent into the carrier fluid to form a product fluid during use.

105. The system of claim 104, wherein the surfactant comprises nonionic surfactant.

106. The system of claim 104, wherein the surfactant comprises cationic surfactant.

107. The system of claim 104, wherein the surfactant comprises silicone surfactant.

108. The system of claim 104, wherein the surfactant comprises organosilicone surfactant.

109. The system of claim 104, wherein the carrier fluid supply is disposed external to the system.

110. The system of claim 104, wherein the carrier fluid comprises water.

111. The system of claim 104, further comprising a pump coupled to the carrier fluid supply and the first conduit, wherein the pump is configured to increase a pressure of the carrier fluid during use.

112. The system of claim 104, wherein the first conduit comprises copper tubing.

113. The system of claim 104, further comprising a valve coupled to the first conduit, wherein the valve is configured to allow a flow of the carrier fluid from the first conduit to the supply conduit during use.

114. The system of claim 113, wherein at least the one valve coupled to the first conduit comprises a solenoid valve.

115. The system of claim 104, further comprising a metering device coupled to the supply conduit, wherein the metering device is configured to determine an amount of product fluid dispensed during use.

116. The system of claim 104, further comprising at least one exit valve coupled to the supply conduit, wherein the at least one exit valve is configured to dispense the product fluid during use.

117. The system of claim 104, wherein the product fluid comprises car wash soap.

118. The system of claim 104, wherein the product fluid comprise automotive appearance care product.

119. A method for dispensing an automotive appearance care product, comprising:
supplying a carrier fluid to a supply conduit;
injecting a surfactant and a foaming agent into the carrier fluid in the supply conduit to form a product fluid; and
dispensing the product fluid.

120. The method of claim 119, wherein the carrier fluid comprises water.

121. The method of claim 119, further comprising increasing a pressure of the carrier fluid using a pump.

122. The method of claim 119, further comprising controlling a flow rate of the carrier fluid with at least one valve.

123. The method of claim 119, further comprising controlling a flow rate of the carrier fluid with at least one valve, wherein the flow rate is predetermined.

124. The method of claim 119, further comprising controlling a flow of the carrier fluid with at least one valve, wherein the valve is controlled by a switch.

125. The method of claim 119, further comprising controlling a flow of the carrier fluid with at least one valve, wherein the valve is controlled by a switch, and wherein the switch is operated by a user of a system.

126. The method of claim 119, further comprising controlling a flow of the carrier fluid with at least one valve, wherein the valve is controlled by a switch, and wherein the switch is operated by a computer.

127. The method of claim 119, further comprising controlling a flow of the carrier fluid with at least one valve, wherein the valve is controlled by a switch, and wherein an amount of the product fluid dispensed is controlled by operation of the switch.

128. The method of claim 119, further comprising dispensing the product fluid through at least one exit valve.

129. The method of claim 119, further comprising determining a volume of the product fluid dispensed.

130. The method of claim 119, further comprising determining a volume of the product fluid dispensed, wherein the volume is determined using a metering device.

131. The method of claim 119, further comprising dispensing the plurality of product fluids in a transportable system.

132. A system configured to dispense an automotive appearance care product, comprising:
a surfactant disposed in a first container;
a first cleaning agent disposed in a second container;
a second cleaning agent disposed in a third container;
a first conduit configured to transport a carrier fluid, wherein the first conduit is coupled to a carrier fluid supply; and
a supply conduit coupled to the first conduit, the supply conduit, comprising:
a first injector, wherein the first injector is further coupled to the first container with a second conduit, and wherein the first injector is configured to inject the surfactant into the carrier fluid to form a product fluid during use;
a second injector, wherein the second injector is further coupled to the second container with a third conduit, and wherein the second injector is configured to inject the first cleaning agent into the carrier fluid to form a product fluid during use;
a third injector, wherein the third injector is further coupled to the third container with a fourth conduit, and wherein the third injector is configured to inject the second cleaning agent into the carrier fluid to form a product fluid during use.

133. The system of claim 132, wherein the surfactant comprises nonionic surfactant.

134. The system of claim 132, wherein the surfactant comprises cationic surfactant.

135. The system of claim 132, wherein the surfactant comprises silicone surfactant.

136. The system of claim 132, wherein the surfactant comprises organosilicone surfactant.

137. The system of claim 132, wherein the carrier fluid supply is disposed external to the system.

138. The system of claim 132, wherein the carrier fluid comprises water.

139. The system of claim 132, further comprising a pump coupled to the carrier fluid supply and the first conduit, wherein the pump is configured to increase a pressure of the carrier fluid during use.

140. The system of claim 132, wherein the first conduit comprises copper tubing.

141. The system of claim 132, further comprising a valve coupled to the first conduit, wherein the valve is configured to allow a flow of the carrier fluid from the first conduit to the supply conduit during use.

142. The system of claim 141, wherein at least the one valve coupled to the first conduit comprises a solenoid valve.

143. The system of claim 132, further comprising a metering device coupled to the supply conduit, wherein the metering device is configured to determine an amount of product fluid dispensed during use.

144. The system of claim 132, further comprising at least one exit valve coupled to the supply conduit, wherein the at least one exit valve is configured to dispense the product fluid during use.

145. The system of claim 132, wherein the product fluid comprises wheel cleaner.

146. The system of claim 132, wherein the product fluid comprise automotive appearance care product.

147. A method for dispensing an automotive appearance care products, comprising:
supplying a carrier fluid to a supply conduit;
injecting a surfactant, a first cleaning agent, and a second cleaning agent into the carrier fluid in the supply conduit to form a product fluid; and
dispensing the product fluid.

148. The method of claim 147, wherein the carrier fluid comprises water.

149. The method of claim 147, further comprising increasing a pressure of the carrier fluid using a pump.

150. The method of claim 147, further comprising controlling a flow rate of the carrier fluid with at least one valve.

151. The method of claim 147, further comprising controlling a flow rate of the carrier fluid with at least one valve, wherein the flow rate is predetermined.

152. The method of claim 147, further comprising controlling a flow of the carrier fluid with at least one valve, wherein the valve is controlled by a switch.

153. The method of claim 147, further comprising controlling a flow of the carrier fluid with at least one valve, wherein the valve is controlled by a switch, and wherein the switch is operated by a user of a system.

154. The method of claim 147, further comprising controlling a flow of the carrier fluid with at least one valve, wherein the valve is controlled by a switch, and wherein the switch is operated by a computer.

155. The method of claim 147, further comprising controlling a flow of the carrier fluid with at least one valve, wherein the valve is controlled by a switch, and wherein an amount of the product fluid dispensed is controlled by operation of the switch.

156. The method of claim 147, further comprising dispensing the product fluid through at least one exit valve.

157. The method of claim 147, further comprising determining a volume of the product fluid dispensed.

158. The method of claim 147, further comprising determining a volume of the product fluid dispensed, wherein the volume is determined using a metering device.

159. The method of claim 147, further comprising dispensing the plurality of product fluids in a transportable system.

160. An apparatus configured to dispense a plurality of automotive appearance care products, comprising:
a plurality of storage containers comprising one or more raw materials, wherein each storage container comprises one raw material;
a plurality of mixing containers coupled to the plurality of storage containers, wherein the plurality of mixing containers are configured to produce a plurality of mixtures during use, wherein each mixture comprises one raw material and a first carrier fluid;
a plurality of mixing systems coupled to the plurality of mixing containers, wherein the mixing systems are configured to combine the mixtures with a second carrier fluid to produce a plurality of product fluids during use;
a plurality of storage vessels coupled to the plurality of mixing systems, wherein each product fluid is stored in one storage vessel;
a plurality of pumps coupled to the plurality of storage vessels, wherein the plurality of pumps are configured to pump product fluids during use; and
at least one dispensing conduit coupled to the plurality of pumps, wherein the at least one dispensing conduit is configured to dispense product fluids during use.

161. The apparatus of claim 160, wherein each mixing container is coupled to each storage container with a conduit.

162. The apparatus of claim 160, wherein each mixing container is coupled to one storage container.

163. The apparatus of claim 160, wherein each mixing container comprises openings for adding powder to the mixing container during use.

164. The apparatus of claim 160, wherein each mixing system is coupled to one mixing container.

165. The apparatus of claim 160, wherein each storage vessel is coupled to one mixing system.

166. The apparatus of claim 160, wherein each pump is coupled to one storage vessel.

167. The apparatus of claim 160, wherein the mixture further comprises a powder.

168. The apparatus of claim 160, further comprising a second mixing system coupled to each mixing container, wherein the second mixing system is configured to combine the first carrier fluid with raw material during use.

169. The apparatus of claim 160, further comprising a second mixing system coupled to each mixing container, wherein the second mixing system is configured to combine the first carrier fluid with raw material during use, and wherein the second mixing system is configured to provide the combined first carrier fluid and raw material to the mixing container during use.

170. The apparatus of claim 160, further comprising a second mixing system coupled to each mixing container, wherein the second mixing system is configured to combine the first carrier fluid with raw material during use, the apparatus further comprising a solenoid valve coupled to the second mixing system, wherein the solenoid valve is configured to control a flow of the first carrier fluid through the second mixing system during use.

171. The apparatus of claim 170, wherein the solenoid valve comprises a normally closed solenoid valve.

172. The apparatus of claim 160, further comprising a second mixing system coupled to each mixing container, wherein the second mixing system comprises a mixing valve, and wherein the mixing valve is configured to combine the first carrier fluid with the raw material during use.

173. The apparatus of claim 172, wherein the mixing valve comprises a venturi valve.

174. The apparatus of claim 160, further comprising a second mixing system coupled to each mixing container, wherein the second mixing system comprises a float placed in the mixing container, and wherein the float is configured to turn off the mixing system when the float rises above an upper specified height in the mixing container during use.

175. The apparatus of claim 160, further comprising a second mixing system coupled to each mixing container, wherein the second mixing system comprises a float placed in the mixing container, and wherein the float is configured to turn on the mixing system when the float falls below a lower specified height in the mixing container during use.

176. The apparatus of claim 160, further comprising a mixer placed in each mixing container.

177. The apparatus of claim 160, further comprising a mixer placed in each mixing container, wherein the mixer is configured to run for a period of about 30 minutes during use.

178. The apparatus of claim 160, further comprising a second mixing system coupled to each mixing container and a mixer placed in each mixing container, wherein a solenoid valve coupled to the second mixing system and the mixer are configured to turn on at substantially the same time during use.

179. The apparatus of claim 160, further comprising a second mixing system coupled to each mixing container and a mixer placed in each mixing container, wherein a solenoid valve coupled to the second mixing system and the mixer are configured to turn on at substantially the same time during use, and wherein the solenoid valve and the mixer are turned on by a switch.

180. The apparatus of claim 160, further comprising a second mixing system coupled to each mixing container and a mixer placed in each mixing container, wherein a solenoid valve coupled to the second mixing system and the mixer are configured to turn on at substantially the same time during use, and wherein the solenoid valve and the mixer are controlled by a timing device.

181. The apparatus of claim 160, wherein a powder is automatically added to each mixing container during use.

182. The apparatus of claim 160, further comprising a second mixing system coupled to each mixing container and a mixer placed in each mixing container, wherein a solenoid valve coupled to the second mixing system and the mixer are configured to turn on at substantially the, same time during use, and wherein a powder is added to the mixing container at substantially the same time.

183. The apparatus of claim 160, wherein each mixing system is coupled to one mixing container with a conduit.

184. The apparatus of claim 160, wherein each mixing system is configured to provide each product fluid to each storage vessel during use.

185. The apparatus of claim 160, wherein each mixing system comprises a mixing valve, and wherein the mixing valve is configured to combine the second carrier fluid with the mixture during use.

186. The apparatus of claim 185, wherein the mixing valve comprises a venturi valve.

187. The apparatus of claim 160, wherein each mixing system comprises a float placed in each storage vessel, and wherein the float is configured to turn on the mixing system when the float falls below a lower specified height.

188. The apparatus of claim 160, wherein each mixing system comprises a float placed in each storage vessel, and wherein the float is configured to turn off the mixing system when the float rises above an upper specified height.

189. The apparatus of claim 160, wherein the mixing systems are configured to siphon the mixtures from the mixing containers.

190. The apparatus of claim 160, wherein each mixing system is coupled to a second carrier fluid supply with a carrier fluid supply conduit.

191. The apparatus of claim 160, wherein the plurality of mixing systems is coupled to a second carrier fluid supply with a carrier fluid supply conduit, and wherein the carrier fluid supply conduit comprises conduit branches coupled to each of the plurality of mixing systems.

192. The apparatus of claim 160, wherein each pump is coupled to each storage vessel with a conduit.

193. The apparatus of claim 160, wherein each pump is configured to be turned on by a user of the apparatus.

194. The apparatus of claim 160, wherein each pump is configured to be turned on by a switch.

195. The apparatus of claim 160, wherein each pump is configured to substantially constantly operate with a supply of power.

196. The apparatus of claim 160, further comprising an air supply conduit coupled to each pump.

197. The apparatus of claim 160, further comprising an air supply conduit coupled to the plurality of pumps, wherein the air supply conduit comprises branch conduits coupled to each of the plurality of pumps.

198. The apparatus of claim 160, further comprising a fluid applicator coupled to an end of each dispensing conduit.

199. The apparatus of claim 160, further comprising a fluid applicator coupled to an end of each dispensing conduit, wherein the fluid applicator is interlocked to turn on an associated pump of the plurality of pumps when the fluid applicator is used.

200. The apparatus of claim 199, wherein the fluid applicator comprises a sprayer.

201. The apparatus of claim 160, further comprising one or more additional dispensing conduits coupled to a dispensing conduit.

202. The apparatus of claim 160, further comprising a metering device coupled to each dispensing conduit, wherein the metering device is configured to determine an amount of product fluid dispensed during use.

203. The apparatus of claim 160, wherein the plurality of mixing systems, the plurality of storage vessels, and the plurality of pumps are placed in a cabinet.

204. The apparatus of claim 203, wherein the cabinet comprises wheels.

205. The apparatus of claim 203, wherein the cabinet comprises wheels, and wherein the cabinet is transportable.

206. The apparatus of claim 160, wherein the plurality of mixing systems is removably coupled from the plurality of mixing containers.

207. The apparatus of claim 203, wherein the plurality of mixing systems is removably coupled to the plurality of mixing containers such that the cabinet can be replaced or transported.

208. The apparatus of claim 160, wherein the apparatus is enclosed such that a user of the apparatus cannot access an interior of the apparatus.

209. The apparatus of claim 160, wherein the apparatus is enclosed such that a user of the apparatus can only turn on and/or turn off the apparatus.

210. The apparatus of claim 160, wherein the first carrier fluid comprises water.

211. The apparatus of claim 160, wherein the second carrier fluid comprises water.

212. The apparatus of claim 160, wherein at least one product fluid comprises a degreaser.

213. The apparatus of claim 160, wherein at least one product fluid comprises an all-purpose cleaner.

214. The apparatus of claim 160, wherein at least one product fluid comprises a car wash soap.

215. The apparatus of claim 160, wherein at least one product fluid comprises a wheel cleaner.

216. The apparatus of claim 160, wherein at least one product fluid comprises a glass cleaner.

217. The apparatus of claim 160, wherein at least one product fluid comprises a dressing fluid.

218. The apparatus of claim 160, wherein the product fluids comprise automotive appearance care products.

219. The apparatus of claim 160, wherein the apparatus is used at an automobile auction.

220. The apparatus of claim 160, wherein a cost to be charged to a user for using the product fluids is based on a number of automobiles the user treats using the product fluids.

221. A system configured to dispense a plurality of automotive appearance care products, comprising:
a plurality of storage containers comprising one or more raw materials, wherein each storage container comprises one raw material;
a plurality of mixing containers coupled to the plurality of storage containers, wherein the plurality of mixing containers are configured to produce a plurality of mixtures during use, wherein each mixture comprises one raw material and a first carrier fluid;
an apparatus, comprising:
a plurality of mixing systems coupled to the plurality of mixing containers, wherein the mixing systems are configured to combine the mixtures with a second carrier fluid to produce a plurality of product fluids during use;
a plurality of storage vessels coupled to the plurality of mixing systems, wherein each product fluid is stored in one storage vessel;
a plurality of pumps coupled to the plurality of storage vessels, wherein the plurality of pumps are configured to pump product fluids during use; and
at least one dispensing conduit coupled to the plurality of pumps, wherein the at least one dispensing conduit is configured to dispense product fluids during use.

222. The system of claim 221, wherein the product fluids comprise automotive appearance care products.

223. The system of claim 221, wherein the system is used at an automobile auction.

224. The system of claim 221, wherein a cost to be charged to a user for using the product fluids is based on a number of automobiles the user treats using the product fluids.

225. An apparatus configured to dispense a plurality of automotive appearance care products, comprising:
a plurality of storage containers comprising one or more raw materials, wherein each storage container comprises one raw material;
a plurality of mixing containers coupled to the plurality of storage containers, wherein each mixing container is coupled to one storage container, wherein the plurality of mixing containers comprise openings for adding powder to each mixing container during use, and wherein the plurality of mixing containers are configured to produce a plurality of mixtures during use, wherein each mixture comprises one raw material, a powder, and a first carrier fluid;
a plurality of mixing systems coupled to the plurality of mixing containers, wherein each mixing system is coupled to one mixing container, and wherein the mixing systems are configured to combine the mixtures with a second carrier fluid to produce a plurality of product fluids during use;
a plurality of storage vessels coupled to the plurality of mixing systems, wherein each storage vessel is coupled to one mixing system, and wherein each product fluid is stored in one storage vessel;
a plurality of pumps coupled to the plurality of storage vessels, wherein each pump is coupled to one storage vessel, and wherein the plurality of pumps are configured to pump product fluids during use; and
at least one dispensing conduit coupled to the plurality of pumps, wherein the at least one dispensing conduit is configured to dispense product fluids during use.

226. The apparatus of claim 225, wherein the product fluids comprise automotive appearance care products.

227. The apparatus of claim 225, wherein the system is used at an automobile auction.

228. The apparatus of claim 225, wherein a cost to be charged to a user for using the product fluids is based on a number of automobiles the user treats using the product fluids.

229. A system configured to dispense a plurality of automotive appearance care products, comprising:
more than one apparatus configured to dispense a plurality of automotive appearance care products, each apparatus comprising:
a plurality of storage containers comprising one or more raw materials, wherein each storage container comprises one raw material;
a plurality of mixing containers coupled to the plurality of storage containers, wherein the plurality of mixing containers are configured to produce a plurality of mixtures during use, wherein each mixture comprises one raw material and a first carrier fluid;
a plurality of mixing systems coupled to the plurality of mixing containers, wherein the mixing systems are configured to combine the mixtures with a second carrier fluid to produce a plurality of product fluids during use;
a plurality of storage vessels coupled to the plurality of mixing systems, wherein each product fluid is stored in one storage vessel;
a plurality of pumps coupled to the plurality of storage vessels, wherein the plurality of pumps are configured to pump product fluids during use; and
at least one dispensing conduit coupled to the plurality of pumps, wherein the at least one dispensing conduit is configured to dispense product fluids during use.

230. The system of claim 229, wherein the product fluids comprise automotive appearance care products.

231. The system of claim 229, wherein the system is used at an automobile auction.

232. The system of claim 229, wherein a cost to be charged to a user for using the product fluids is based on a number of automobiles the user treats using the product fluids.

233. A method for dispensing a plurality of automotive appearance care products, comprising:
supplying one or more raw materials and a first carrier fluid to a plurality of mixing containers;
producing a plurality of mixtures from the one or more raw materials and the first carrier fluid in the plurality of mixing containers, wherein one mixture is produced in each mixing container;
combining the plurality of mixtures with a second carrier fluid to produce a plurality of product fluids;
providing the plurality of product fluids to a plurality of storage vessels prior to dispensing the plurality of product fluids, wherein one product fluid is provided to each storage vessel;
dispensing the plurality of product fluids for use as automotive appearance care products; and
assessing a cost to be charged to a user for using the automotive appearance care products based on a number of automobiles the user treats using the automotive appearance care products.

234. The method of claim 233, further comprising combining the first carrier fluid with the one or more raw materials prior to supplying the products and the first carrier fluid to the mixing containers.

235. The method of claim 233, further comprising supplying one or more powders to the plurality of mixing containers.

236. The method of claim 233, further comprising supplying one or more powders to the plurality of mixing containers and producing the plurality of mixtures from the one or more raw materials, the one or more powders, and the first carrier fluid.

237. The method of claim 235, further comprising automatically supplying one or more powders to the plurality of mixing containers.

238. The method of claim 233, further comprising supplying the one or more raw materials from a plurality of storage containers.

239. The method of claim 233, further comprising automatically producing the plurality of mixtures.

240. The method of claim 233, further comprising automatically providing the plurality of product fluids to the plurality of storage vessels.

241. The method of claim 233, further comprising storing the plurality of product fluids in the plurality of storage vessels prior to dispensing the plurality of product fluids.

242. The method of claim 233, further comprising dispensing the plurality of product fluids using a pump.

243. The method of claim 233, further comprising metering the dispensing of the plurality of product fluids with one or more metering devices.

244. The method of claim 233, further comprising siphoning the plurality of mixtures to the second carrier fluid with a venturi valve.

245. The method of claim 233, further comprising producing the plurality of product fluids and providing the plurality of product fluids to the plurality of storage vessels using a mixing system.

246. The method of claim 233, further comprising controlling the production of the plurality of mixtures such that a mixture cannot be produced until a mixing container is substantially empty.

247. The method of claim 233, further comprising dispensing the plurality of product fluids through a fluid applicator.

248. The method of claim 233, further comprising dispensing the plurality of product fluids for use at an automobile auction.

249. The method of claim 233, wherein a user is only allowed to control producing of the plurality of mixtures by operating a switch and dispensing of the product fluids by operating a dispensing valve.

250. The method of claim 233, wherein the cost to be charged to the user includes chemical costs.

251. The method of claim 233, wherein the cost to be charged to the user includes material costs.

252. The method of claim 233, wherein the cost to be charged to the user includes freight costs.

253. The method of claim 233, wherein the cost to be charged to the user includes labor costs.

254. The method of claim 233, further comprising charging a user of the automotive appearance care products based on the number of automobiles the user treats using the automotive appearance care products.

255. The method of claim 233, further comprising charging a cost to a user of the automotive appearance care products, wherein the cost is based on a number of automobiles the user treats using the automotive appearance care products.

256. The method of claim 233, further comprising charging a cost to a user of the automotive appearance care products, wherein the cost is determined by multiplying a number of automobiles the user treats using the automotive appearance care products by a set rate for treating each automobile.

257. The method of claim 256, wherein the set rate is based on an average amount of automotive appearance care products needed to treat each automobile.

258. The method of claim 256, wherein the set rate includes chemical costs.

259. The method of claim 256, wherein the set rate includes material costs.

260. The method of claim 256, wherein the set rate includes freight costs.

261. The method of claim 256, wherein the set rate includes labor costs.

262. The method of claim 256, further comprising adjusting the set rate based on the size of the automobiles to be treated.

263. The method of claim 256, further comprising adjusting the set rate based on a type of automobile to be treated.

264. The method of claim 256, further comprising adjusting the set rate based on the location for dispensing the automotive appearance care products.

265. A method for dispensing a plurality of automotive appearance care products, comprising:
producing a plurality of mixtures from one or more raw materials and a first carrier fluid;
combining the plurality of mixtures with a second carrier fluid to produce a plurality of product fluids;
dispensing the plurality of product fluids for use as automotive appearance care products; and
assessing a cost to be charged to a user for using the automotive appearance care products based on a number of automobiles the user treats using the automotive appearance care products.

266. A method for dispensing a plurality of automotive appearance care products, comprising:
producing a plurality of mixtures from one or more raw materials and a first carrier fluid;
combining the plurality of mixtures with a second carrier fluid to produce a plurality of product fluids;
storing the plurality of product fluids;
dispensing the plurality of product fluids for use as automotive appearance care products; and
assessing a cost to be charged to a user for using the automotive appearance care products based on a number of automobiles the user treats using the automotive appearance care products.

267. A method for dispensing a plurality of automotive appearance care products, comprising:
dispensing a plurality of product fluids for use as automotive appearance care products; and
charging a cost to a user of the automotive appearance care products, wherein the cost is determined by multiplying a number of automobiles the user treats using the automotive appearance care products by a set rate for treating each automobile.

268. The method of claim 267, further comprising producing a plurality of mixtures from one or more raw materials and a first carrier fluid, and combining the plurality of mixtures with a second carrier fluid to produce the plurality of product fluids.

269. The method of claim 267, further comprising storing the plurality of product fluids prior to dispensing the plurality of product fluids.

270. The method of claim 267, further comprising dispensing the plurality of product fluids for use as automotive appearance care products from a single apparatus.

271. A method for dispensing a plurality of automotive appearance care products, comprising:
producing a plurality of mixtures from one or more raw materials and a first carrier fluid;
combining the plurality of mixtures with a second carrier fluid to produce a plurality of product fluids;
dispensing the plurality of product fluids for use as automotive appearance care products; and
charging a cost to a user of the automotive appearance care products, wherein the cost is based on a number of automobiles the user treats using the automotive appearance care products.

272. A method for dispensing a plurality of automotive appearance care products, comprising:
producing a plurality of mixtures from one or more raw materials and a first carrier fluid;
combining the plurality of mixtures with a second carrier fluid to produce a plurality of product fluids;
storing the plurality of product fluids;
dispensing the plurality of product fluids for use as automotive appearance care products; and
charging a cost to a user of the automotive appearance care products, wherein the cost is based on a number of automobiles the user treats using the automotive appearance care products.

273. A method for dispensing a plurality of automotive appearance care products, comprising:
supplying one or more raw materials, one or more powders, and a first carrier fluid to a plurality of mixing containers;
producing a plurality of mixtures from the one or more raw materials, the one or more powders, and the first carrier fluid in the plurality of mixing containers, wherein one mixture is produced in each mixing container;
combining the plurality of mixtures with a second carrier fluid to produce a plurality of product fluids;
providing the plurality of product fluids to a plurality of storage vessels prior to dispensing the plurality of product fluids, wherein one product fluid is provided to each storage vessel;
dispensing the plurality of product fluids for use as automotive appearance care products; and
assessing a cost to be charged to a user for using the automotive appearance care products based on a number of automobiles the user treats using the automotive appearance care products.

274. The method of claim 273, further comprising dispensing the plurality of product fluids for use at an automobile auction.

275. A method for dispensing a plurality of automotive appearance care products, comprising:
supplying one or more raw materials, one or more powders, and a first carrier fluid to a plurality of mixing containers;
producing a plurality of mixtures from the one or more raw materials, the one or more powders, and the first carrier fluid in the plurality of mixing containers, wherein one mixture is produced in each mixing container;
combining the plurality of mixtures with a second carrier fluid to produce a plurality of product fluids;
providing the plurality of product fluids to a plurality of storage vessels prior to dispensing the plurality of product fluids, wherein one product fluid is provided to each storage vessel;
dispensing the plurality of product fluids for use as automotive appearance care products; and
wherein a user is only allowed to control producing of the plurality of mixtures by operating a switch and dispensing of the product fluids by operating a dispensing valve.

276. The method of claim 275, further comprising assessing a cost to be charged to a user for using the automotive appearance care products based on a number of automobiles the user treats using the automotive appearance care products.

277. The method of claim 275, further comprising dispensing the plurality of product fluids for use at an automobile auction.

278. A method for dispensing a plurality of automotive appearance care products, comprising:
supplying one or more raw materials and a carrier fluid to one or more mixing containers;
forming one or more mixtures from the one or more raw materials and the carrier fluid in the mixing containers, wherein one mixture is formed in one mixing container;
providing the one or more mixtures to one or more storage vessels, wherein one mixture is provided to one storage vessel; and
dispensing the one or more mixtures for use as one or more automotive appearance care products.

279. The method of claim 278, further comprising assessing a cost to be charged to a user for using the automotive appearance care products based on a number of automobiles the user treats using the automotive appearance care products.

280. The method of claim 278, further comprising combining the one or more mixtures with a second carrier fluid prior to dispensing the mixtures for use as automotive appearance care products.

281. The method of claim 278, further comprising dispensing the plurality of product fluids for use at an automobile auction.

282. A method for dispensing a plurality of automotive appearance care products, comprising:
supplying a first raw material and a first carrier fluid to a first mixing container;
forming a first mixture from the first raw material and the first carrier fluid;
supplying a second raw material and a second carrier fluid to a second mixing container;
forming a second mixture from the second raw material and the second carrier fluid;
combining the first mixture and the second mixture to form a third mixture;
providing the third mixture to a storage vessel; and
dispensing the third mixture for use as an automotive appearance care product.

283. The method of claim 282, further comprising assessing a cost to be charged to a user for using the automotive appearance care product based on a number of automobiles the user treats using the automotive appearance care product.

284. The method of claim 282, further comprising storing the first mixture in a storage, vessel before combining the first mixture and the second mixture.

285. The method of claim 282, further comprising storing the second mixture in a storage vessel before combining the first mixture and the second mixture.

286. The method of claim 282, further comprising dispensing the plurality of product fluids for use at an automobile auction.
